(19) United States
(12) Patent Application Publication
(10) Pub. No.: US 2013/0343536 A1
(43) Pub. Date: Dec. 26, 2013

(54) Incorporating Actionable Feedback to Dynamically Evolve Campaigns

(71) Applicants: Kuntal Dey, West Bengal (IN); Seema Nagar, Tahsil-Khanpur (IN)

(72) Inventors: Kuntal Dey, West Bengal (IN); Seema Nagar, Tahsil-Khanpur (IN)

(73) Assignee: INTERNATIONAL BUSINESS MACHINES CORPORATION, Armonk, NY (US)

(21) Appl. No.: 13/530,398

(22) Filed: Jun. 22, 2012

(51) Int. Cl. H04M 3/00

(52) U.S. Cl. 379/266.08

(57) ABSTRACT

Techniques, an apparatus and an article of manufacture for incorporating contextual reinforcement to dynamically evolve an information campaign. A method includes determining an evolution of an information campaign with respect to at least one end objective up to a pre-determined point of advancement in the life cycle of the information campaign, predicting a future progression of the information campaign from the pre-determined point of advancement with respect to the at least one end objective based on said evolution and at least one learned model of progression, wherein said future progression includes a prediction of a potential outcome of the information campaign at one or more given time points in the life cycle, and incorporating a contextual reinforcement campaign into the information campaign to dynamically evolve the information campaign toward the at least one end objective, creating an evolved information campaign, wherein the reinforcement campaign is based on said future progression.

### FIELD OF THE INVENTION

Embodiments of the invention generally relate to information technology, and, more particularly, to techniques for dynamically evolving information campaigns.

### BACKGROUND

Telco campaigns (that is, information or marketing campaigns conducted by telecommunications enterprises) are often decoupled or loosely coupled from each other in terms of learning a progression life cycle. Commonly, a Telco campaign, even if monitored, is acted upon for quality and success as it runs at very basic levels. For example, in many approaches, the success of a campaign is not finalized until the end of the campaign, and by the time a Telco campaign failure is detected, there is no effective way to control or undo the damage. Accordingly, a need exists for improving effectiveness of campaigns and developing intelligence to understand and react in a timely manner based upon exact progress of a campaign.

### SUMMARY

In one aspect of the present invention, techniques for incorporating actionable feedback to dynamically evolve campaigns are provided. An exemplary computer-implemented method for incorporating contextual reinforcement to dynamically evolve an information campaign can include steps of determining an evolution of an information campaign with respect to at least one end objective up to a pre-determined point of advancement in the life cycle of the information campaign, predicting a future progression of the information campaign from the pre-determined point of advancement with respect to the at least one end objective based on said evolution and at least one learned model of progression, wherein said future progression includes a prediction of a potential outcome of the information campaign at one or more given time points in the life cycle, and incorporating a contextual reinforcement campaign into the information campaign to dynamically evolve the information campaign toward the at least one end objective, creating an evolved information campaign, wherein the reinforcement campaign is based on said future progression.

Additionally, another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and operative to perform noted method steps.

Yet further, another aspect of the invention or elements thereof can be implemented in the form of means for carrying out the method steps described herein, or elements thereof; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an embodiment of the present invention;

FIG. 2 is a flow diagram illustrating techniques for incorporating contextual reinforcement to dynamically evolve an information campaign, according to an embodiment of the invention; and

FIG. 3 is a system diagram of an exemplary computer system on which at least one embodiment of the invention can be implemented.

### DETAILED DESCRIPTION

As described herein, an aspect of the present invention includes incorporating goal-based actionable feedback to dynamically evolve information campaigns (for example, marketing campaigns). At least one embodiment of the invention includes campaign status monitoring to auto-derive feedback for an ongoing information campaign and providing actionable contextual reinforcement campaigns aiming to drive the original information campaigns towards original success criteria.

Accordingly, as detailed herein, aspects of the invention include re-directing information campaigns heading towards less-than-expected or less-than-desired levels of success towards desirable success levels. As also described herein, campaign-compatibility scores can be computed for targets (individuals or groups) with respect to a class of campaigns and with respect to contextual campaigns.

Specifically, at least one embodiment of the invention includes monitoring an ongoing information campaign and computing compatibility scores with respect to campaign classes to dynamically auto-derive feedback per customer segment and/or per campaign class during the information campaign run-time. Items and/or data being monitored can include the number and rates of conversions of a target population, evolution of certain attributes among the targets, etc. As detailed herein, campaign compatibility scores are computed based on past behavior of targets towards campaigns of the given campaign class and are dynamically updated with every ongoing information campaign of the given campaign class. Further, at least one embodiment of the invention includes learning and launching one or multiple contextual reinforcement campaigns on any ongoing information campaign with respect to ongoing information campaign runs, customer segment groups, campaign classes of ongoing campaign runs, and/or prior contextual campaigns given the campaign class.

As used herein, a number of terms are defined as follows. A campaign class refers to a grouping of given (usually similar) campaigns, which can be identified via machine learning, artificial intelligence, human inputs or other means. Parameters considered in order to group campaigns can be targeted towards a same or similar age group, similar communities such as cliques, groups of friends with similar buying behavior, the end goal of increasing the penetration of a product by at least K percentage, etc. Further, such classes can include one or more campaigns.

A success curve is used to quantify the evolution of a given information campaign, and can be further used to characterize the campaign class to which the information campaign belongs. A success curve can also be leveraged to measure the success of a given information campaign with respect to its current set of attributes via comparisons with success curves of other campaigns of the same campaign class. Additionally, as detailed herein, a success curve can be compared with the expected curve (or trend) of the evolution of success status over time and/or over multiple campaigns. Such a comparison aims to identify, often early in the life cycle of an information campaign, whether the information campaign is headed towards the desired goal. The deviation of a current status of a given running information campaign can also be quantified with respect to its expected status at any given time. Further, a success curve can be representative of a group (target) level or a campaign level.

As noted, automatic and semi-automatic reinforcement are also described in connection with at least one embodiment of the invention. In automatic reinforcement, existing relevant reinforcement campaigns are identified in an appropriate context from a repository of reinforcement campaigns. Such a technique includes examining and learning from past reinforcement campaigns, target groups for the same campaign class, and the current status of targets. Such reinforcement campaigns are scored and the top-k (that is, a predetermined number) reinforcement campaigns are auto-launched (k=1, for example). In semi-automatic reinforcement, existing relevant reinforcement campaigns are identified in an appropriate context from the repository of reinforcement campaigns. Context refers to the class of the information campaign, target groups, a current target status with respect to campaigns, and past reinforcement campaigns. Such reinforcement campaigns are scored and the top-k reinforcement campaigns are presented (possibly with scoring factors or scoring rules) to a human reviewer for selection and/or launch.

Also, as described herein, at least one embodiment of the invention includes evaluating success and/or failure of information campaigns. Evaluation can occur at specified intervals of time after an information campaign is launched, and evaluation is based upon learning from campaigns belonging to the same class, as found at similar stages from respective launches. If, for an information campaign, a sufficiently high number (that is, greater than a pre-determined threshold) of failures occur for a prediction on an ongoing basis, the information campaign is labeled as a potential failure. As described herein, the prediction refers to a prediction of the outcome of the current information campaign on the current targets on a basis of the current status of targets and past behavior of targets for past campaigns belonging to the campaign class.

In accordance with at least one embodiment of the invention, learning and/or determining success curves from a class of given (similar) campaigns enables an understanding of expected trends of achievement of success of a class of campaigns. This also enables learning and/or determining an outcome-based similarity between campaigns as well as classifying campaigns.

By way merely of illustration, consider the following example. Campaign 1 intends to make groups of size 7 or more opt in for Digital TV. The timeframe for running this information campaign is 30 days, and success is stated to be obtained for a group if 70% of the people in the group opt into Digital TV. There were 50 target groups on which the information campaign was run.

Snapshots of success were taken at every alternate day (15 snapshots over the course of 30 days). An example embodiment of the invention could generate 50 (one per target group)+1 (for the overall success)=51 success curves, each curve having 15 points (one point per snapshot). An example intermediate snapshot might include the following: At the end of the 10th day (the 5th snapshot), it was observed that 30 groups had already opted into the Digital TV campaign.

At the end of the information campaign, a success level of 80% was achieved, so 40[1] out of the 50 groups opted in and 10[0] did not. As used herein in these examples, bracketed numbers such as [1] and [0] are labels used for ease of reading and for reference. Target level feedback is incorporated into system and evaluated at the end of each information campaign. For example, campaign-class-friendliness scores (CS) and reinforcement-campaign-class-friendliness-scores (RCS) are updated. Compatibility scores and friendliness scores are used interchangeably herein. Note that CS and RCS scores are calculated with respect to a particular class of campaigns and a particular class of reinforcement campaigns. Continuing with the above example, score update policies may include the following:
If there is an opt-in without reinforcement, then CS=CS+2.
If there is an opt-in with reinforcement, then CS=CS+1 and RCS=RCS+1.
If there is not an opt-in even after a reinforcement campaign, then CS=CS−2 and RCS=RCS−1.
If there is not an opt-in without a reinforcement campaign, then CS=CS−1.

For [0], CS=−1 and RCS=0, while for [1], CS=2 and RCS=0.

Further, information Campaign 2 intends to make groups of size 7 or more opt in for Social Web of Things (SWOT). The timeframe for running this information campaign is 30 days, and success is stated to be obtained for a group if 80% of the people in the group opt into SWOT. There are 70 target groups on which the information campaign will be run. Snapshots will be taken in the same manner as the above-detailed information Campaign 1.

At the end of the 10th day (the 5th snapshot), it is observed that 22 groups have opted in for the SWOT campaign. It is further observed that 15 of these groups belong to the 50 groups that information Campaign 1 had been run upon, and 7 of these groups are among the (70−50)=20 freshly selected groups. Accordingly, the success curve for information Campaign 2, at this point in time, is showing multiple negative side groups. For example, the information campaign is on the negative side (by learning from information Campaign 1). Negative side groups indicate that the information campaign success rate is below the expected levels. Also, this information campaign has now shown four failures out of the five status records, which is greater than the threshold. Accordingly, a reinforcement campaign is triggered.

At the end of information Campaign 2, 55 groups opted in and 15 groups did not. Also, note that the reinforcement campaign was run on (40−15)=25 groups because at the end of the 10th day, only 15 out of the 40 groups that had converted for Campaign 1 had opted in for Campaign 2, and the rest of the groups had not. The summary for Campaign 2 is as follows:
Offered: 70
Failed: 15[0]
Successes: 55[1]
Reinforced: 25[2]
Reinforced Success: 23[3]
Reinforced Failed: 2[4]
38 [5] successes among 40 success from Campaign 1 (15 [6] direct, 23 [7] with reinforcement).
[1]−[5]=17 remaining successes, 15 [8] among freshly selected, 2 [9] from failure of Campaign 1.
From [0], 8 [10] failed Campaign 1 and Campaign 2, 5 [11] did not fail Campaign 2, 2 [4] failed Campaign 1 but not Campaign 2 and with Reinforcement [6].

Additionally, CS and RCS are updated at the end of the evolved campaign as follows:
[6]: CS=4 and RCS=0
[7]: CS=3 and RCS=1
[4]: CS=0 and RCS=−1
[8]: CS=2 and RCS=0
[9]: CS=0 and RCS=0
[10]: CS=−2 and RCS=0
[11]: CS=−1 and RCS=0.

Also, information Campaign 3 intends to make groups of size 7 or more opt in for Social Web of Thought-Sharing (SWOTh): The timeframe for running this information campaign is 30 days, and success is stated to be obtained for a group if 75% of the people in the group opt into SWOTh. There are 90 target groups on which the information campaign will be run. Snapshots will be taken in the same manner as the above-detailed information Campaign 1.

At the end of the 10th day (the 5th snapshot), it is observed that only 20 groups have opted in for the SWOTh campaign, while the remaining 70 target groups have not. Also, four out of five success curve points indicate failure. The summary after the 10th day (5th snapshot) appears as follows:
20 opt-ins:
   8 converted from 50 (Campaign 1 and Campaign 2)
   2 converted from (Campaign 1 and Campaign 2 and Reinforcement (Campaign 2))
   5 from (Campaign 2-Campaign 1)
   1 from (Campaign 2 and Reinforcement (Campaign 2)-Campaign 1) and 4 fresh.
The 70 groups that have not opted in are from the following categories:
   Failure on the 10th day: 70: 40 from Campaign 1 and Campaign 2 [1], 14 from (Campaign 2-Campaign 1) [2], 16 fresh [3].
   [1a] Of these 40: 12 converted from Campaign 1 and Campaign 2, and 15 converted from Campaign 1 and Campaign 2 and Reinforcement (Campaign 2).
   [1b] Of these 40: 3 converted from Campaign 1 and not Campaign 2 (1 of these 3 were Reinforcement (Campaign 2) Failed).
   [1c] Of these 40: 6 converted not from Campaign 1 and not from Campaign 2 (1 of these were Reinforcement (Campaign 2) Failed).
   [1d] Of these 40: 4 converted not from Campaign 1 but from Campaign 2 (3 converted not from Campaign 1 but from Campaign 2 and Reinforcement (Campaign 2)).
[2] Of these 14: 8 converted from Campaign 2, and 6 converted not from Campaign 2 (2 of these 8 converted with Reinforcement (Campaign 2)).
[3] No further information.

The above-detailed campaign summary provides conclusions such as the following. For example, due to reinforcement campaigns, more conversions happened that would not have happened in the absence of the reinforcements. Also, the appropriate reinforcement campaign can be identified for the chronologically later campaigns based upon campaign class, target groups, target status with respect to those campaigns, and past reinforcement campaigns.

Too many failures have been observed too many times (four out of five) in the system now. Accordingly, reinforcement campaigns for C3 are to be launched. In accordance with at least one embodiment of the invention, a reinforcement campaign can be selected for this example as follows.

If a significant fraction of the 15 targets in [1a] have the same success curve as in Campaign 2 after the end of 10th day, the reinforcement campaigns for the set of people belonging to [1a] can be picked directly from successful reinforcement campaigns for information Campaign 2. For targets belonging to [1b], the reinforcement campaign has no a priori information about success, but it has a priori information about failure. The reinforcement campaign will be designed accordingly. In summary, the reinforcement campaign determiner for this group will learn from the failure of Reinforcement (Campaign 2), given the target group, the success of Campaign 1, and the failure of Campaign 2.

For targets belonging to [1c], the a priori information pertains to the failure of Campaign 1, Campaign 2 and Reinforcement (Campaign 2). The learning for Reinforcement (Campaign 3) is to occur accordingly; that is, learning from the failure of Reinforcement (Campaign 2), given the target group, and the failures of Campaign 1 and Campaign 2. Information to be learned can include the potential outcome of a campaign from campaign objectives, campaign attributes, target group attributes, past reinforcement campaigns, campaign class attributes, etc. For targets belonging to [1d], the a priori information pertains to the failure of Campaign 1, the success of Campaign 2 and the success of Reinforcement (Campaign 2). The learning for Reinforcement (Campaign 3) is to occur accordingly.

For targets belonging to [2], reinforcement learning for Reinforcement (Campaign 3) will occur given the successes and failures of Campaign 1 and Campaign 2 and Reinforcement (Campaign 2). Optionally, for targets belonging to [3], the launch of Reinforcement (Campaign 3) can be carried out using similar mechanisms as the launch of Reinforcement (Campaign 2) during Campaign 2.

Also, in this example, information Campaign 4 intends to make groups of size 7 or more opt in for a multiplayer game. Information Campaign 4 is run as a parallel independent campaign with respect to Campaign 3, and belongs to the same campaign class as Campaign 1 and Campaign 2. The target size that qualifies because of matching attributes by other methods=90. Constraints include the fact that the campaign can be offered to only 74 due to budget limitations. Accordingly, target selection includes the following:
53 from [6]+[7]+[8] of Campaign 2 because of acceptable CS/RCS scores.

For the selection of the remaining (74−53)=21, three options are provided as follows:
Option 1: Select 20 from the fresh targets, and use a tie-breaker to select one out of the two from [9].
Option 2: Select two from [9], and use a tie-breaker to select 19 from the 20 fresh targets. (Tie-breaking can include a random process or can be controlled externally by an enterprise.)
Option 3: Select 21 out of 22 from the combination of [9] and the 20 fresh targets.

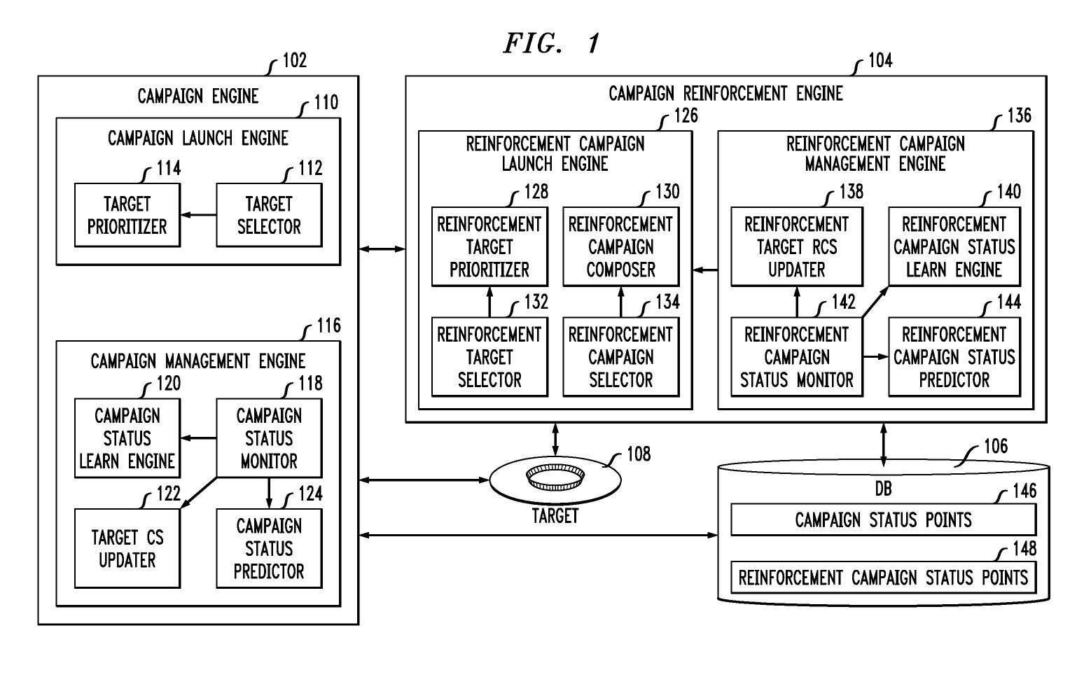

FIG. 1 is a diagram illustrating system architecture, according to an embodiment of the present invention. By way of illustration, FIG. 1 depicts a campaign engine 102, which includes a campaign launch engine 110 and a campaign management engine 116. The campaign launch engine 110 includes a target prioritizer module 114 and a target selector module 112, which carry out target selection and prioritization of targets with respect to the campaign. The campaign management engine 116 includes a campaign status monitor module 118, a campaign status learning engine (non-contextual learner) 120, a campaign status predictor module 124 and a target CS updater module 122 to update a target priority campaign compatibility score with respect to a given campaign class.

FIG. 1 also depicts a campaign reinforcement engine 104, which includes a reinforcement campaign launch engine 126 and a reinforcement campaign management engine 136. The reinforcement campaign launch engine 104 includes a reinforcement campaign target selection module 132 and a reinforcement campaign composer module 130 for automatic or semi-automatic reinforcement campaign composition. The reinforcement campaign launch engine 104 also includes a reinforcement campaign selection module 134 (which includes the target, the campaign status, and the output of the contextual learner), and a reinforcement target prioritizer module 128 to carry out prioritization of targets with respect to the campaign.

The reinforcement campaign management engine 136 includes a reinforcement campaign status monitor module 142, a reinforcement campaign status learning engine 140 (including a contextual learner) and a reinforcement campaign status predictor module 144. The reinforcement campaign management engine 136 also includes a reinforcement target RCS updater module 138 to update target priority reinforcement campaign compatibility scores with respect to the given reinforcement campaign class which, in turn, is selected with respect to campaign class, target group, target status with respect to the campaign, etc.

As also illustrated, FIG. 1 additionally depicts a target set 108, and a database 106 which includes a campaign status points component 146 and a reinforcement campaign status points component 148.

More specifically, the campaign launch engine 110 receives inputs from the target selector module 112 and prioritizes the targets from the target set 108 using the target prioritizer module 114. Accordingly, the campaign launch engine 110 launches the campaign on the target set 108. Campaign management engine 116 begins managing the lifecycle of the ongoing campaign. The campaign status monitor module 118, which is a component of the campaign management engine 116, monitors the state of the current campaign by collecting desirable attributes and success statuses and saving the campaign status points 146 into the database 106. The campaign status monitor module 118 further accesses knowledge obtained by campaign status learning engine 120 from prior campaigns belonging to the campaign class of the current campaign, and uses this knowledge to predict the outcome of the campaign using the campaign status predictor module 124 at each of the campaign status points 146. The target CS updater module 122 updates the campaign compatibility score of the campaign targets with respect to the campaign class in the database 106.

Additionally, if a sufficiently high number (higher than a pre-determined threshold) of failures are predicted by the campaign status predictor module 124 during the campaign run-time for a given campaign of a given campaign class, the campaign reinforcement engine 104 is invoked for the subset of the target set 108 predicted to be associated with a failure.

As noted, the campaign reinforcement engine 104 includes a reinforcement campaign launch engine 126 and a reinforcement campaign management engine 136. In the reinforcement campaign launch engine 126, the reinforcement target selector module 132 selects the targets from the set of predicted failures. The reinforcement target prioritizer module 128 prioritizes among the set of targets selected by reinforcement target selector module 132. The reinforcement campaign selector module 134 selects from existing reinforcement campaigns. The selection is provided to the reinforcement campaign composer module 130 that, in turn, automatically or semi-automatically composes appropriate reinforcement campaigns for the selected target subsets.

The reinforcement campaign management engine 136 becomes active once the first reinforcement campaign is launched. For every target, the reinforcement campaign management engine 136 monitors the status of the reinforcement campaign using the reinforcement campaign status monitor module 142. The reinforcement campaign status monitor module 142 monitors the state of the current set of reinforcement campaigns by collecting desirable attributes and success statuses and saving the campaign status points 148 in database 106. The reinforcement campaign status monitor module 142 accesses knowledge obtained by reinforcement campaign status learning engine 140 from appropriate prior reinforcement campaigns, and uses this knowledge to predict the outcome of the reinforcement campaigns using the reinforcement campaign status predictor module 144 at each of the reinforcement campaign status points 148. Also, the reinforcement target RCS updater module 138 updates the reinforcement campaign compatibility score of the reinforcement campaign targets in database 106.

At least one embodiment of the invention, as detailed herein, includes monitoring and recording the state of a campaign including the attributes of the target groups. Information and/or data to be monitored can include the number and rates of conversions of target population, evolution of certain attributes among the targets, etc. Learning attributes can include determining information such as success curve fitting parameters, a distance from the goal, attributes of the targets, attributes of the campaigns, etc. Additionally, the outcome (success or failure) of a given information campaign can be predicted given its success curve (as it builds up) and the learning of success for the class of campaigns to which it belongs. The differences between the actual success curve and the expected success curve can be quantified via analysis based upon statistical parameters. Expected success curves are generated using all points (p,k), where p is the average/expected number of converted targets based upon all of the previous campaigns of this given campaign class until time k measured from the campaigns launch times. Example embodiments of the invention can include using successful campaigns, and may opt to include failed campaigns for computing differences.

As noted, such differences can provide a basis for selecting an applicable reinforcement campaign. Additionally, at least one embodiment of the invention includes learning and/or determining reinforcement campaigns for an ongoing campaign given a campaign class, a set of campaigns in a selected history, the reinforcement campaign classes that have been associated with this campaign class at some point in history, a set of reinforcement campaigns belonging to one of the reinforcement campaign classes, a set of recorded states and success curves in the history of the campaign class and reinforcement campaign class (the state of each reinforcement campaign class being a function of some campaign within the given class) as well as this campaign, time elapsed since the launch of the campaign, targets and priorities of the targets as available at the time of learning, etc.

Additionally, at least one embodiment of the invention includes assigning and updating priority values of targets based upon history and behavior of the targets. Further, such values can be used to select targets for further information campaigns and future reinforcement campaigns. By way of example, a campaign-class-friendliness score can be used to prioritize targets given a campaign and its campaign class. A reinforcement-campaign-class-friendliness-score can be used to decide the priority of a target when reinforcing with respect to an information campaign belonging to a campaign class. Also, scores can also be derived, for example, a non-reinforcement-campaign-class-friendliness-score, which can be treated as a derived score given the reinforcement-campaign-class-friendliness-score attribute and a negation operator in the campaign composition engine.

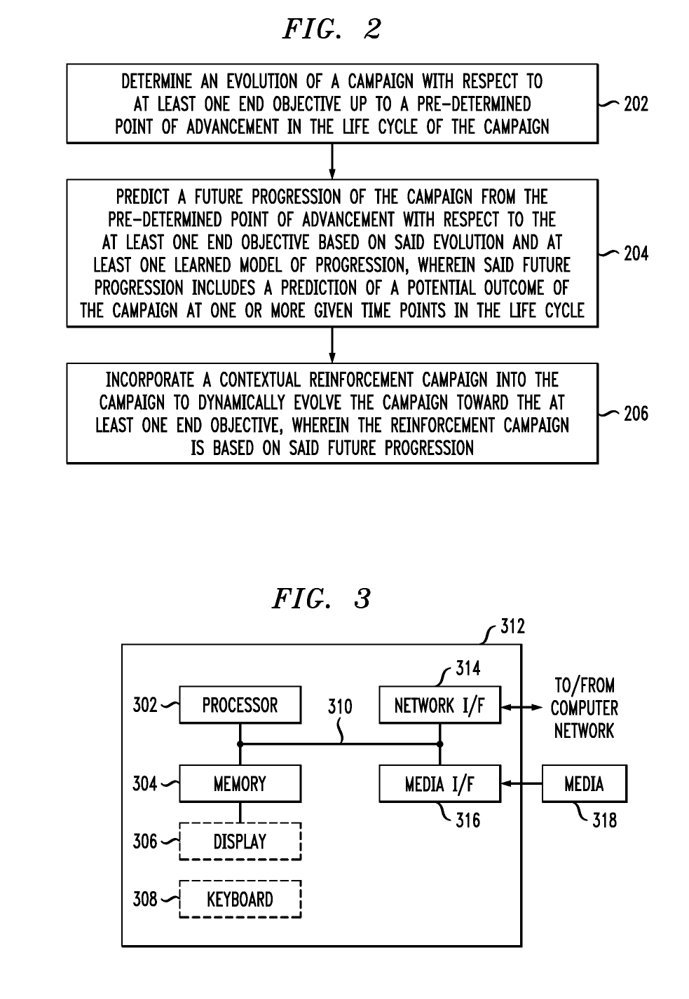

FIG. 2 is a flow diagram illustrating techniques for incorporating contextual reinforcement to dynamically evolve an information campaign, according to an embodiment of the present invention. Step 202 includes determining an evolution of an information campaign with respect to at least one end objective up to a pre-determined point of advancement in the life cycle of the information campaign. Determining can include determining an evolution of a class of campaigns, wherein a class refers to a grouping of related campaigns.

Also, determining can include generating a success curve to quantify the evolution of the information campaign and to characterize a campaign class to which the information campaign belongs. At least one embodiment of the invention can include leveraging the success curve to measure success of the information campaign with respect to the at least one end objective via comparison with success curves of other campaigns of the same campaign class. Additionally, at least one embodiment of the invention can include comparing the success curve with an expected curve of evolution of success status over time to quantify the deviation of a current status of the information campaign with respect to an expected status at a given time.

Further, this determining step can include evaluating the information campaign at one or more specified intervals of time after the information campaign is launched.

Step 204 includes predicting a future progression of the information campaign from the pre-determined point of advancement with respect to the at least one end objective based on said evolution and at least one learned model of progression, wherein said future progression includes a prediction of a potential outcome of the information campaign at one or more given time points in the life cycle. A learned model of progression can be based upon learning derived from campaigns belonging to the same class as the information campaign, and as found at similar stages from respective launches as the information campaign.

The predicting step can include labeling the information campaign a potential failure if a number of failures greater than a pre-determined threshold of failures occur in the future progression. Further, at least one embodiment of the invention includes triggering composition of a contextual reinforcement campaign if the number of failures surpasses the pre-determined threshold of failures occur in the future progression.

As detailed herein, both the determining and predicting steps can be carried out at a target level, wherein a target includes an individual or a group of individuals participating in the information campaign, or across all target groups.

Step 206 includes incorporating a contextual reinforcement campaign into the information campaign to dynamically evolve the information campaign toward the at least one end objective, creating an evolved information campaign, wherein the reinforcement campaign is based on said future progression. This incorporating step can be carried out automatically by identifying existing reinforcement campaigns in an appropriate context from a repository, scoring said identified reinforcement campaigns and automatically incorporating the top-k (a predetermined number of) reinforcement campaigns. Also, the incorporating step can be carried out semi-automatically by identifying existing reinforcement campaigns in an appropriate context from a repository, scoring said identified reinforcement campaigns and presenting the top-k identified reinforcement campaigns to a human reviewer for incorporation. As detailed herein, the context for a contextual reinforcement campaign is derived from the information campaign, campaign class, targets of the information campaign and/or prior contextual campaigns within the campaign class.

The techniques depicted in FIG. 2 can additionally include computing a campaign-compatibility score for a target of the information campaign with respect to campaign class and the contextual reinforcement campaign.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and operative to perform exemplary method steps.

Additionally, an aspect of the present invention can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As noted, aspects of the present invention may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, re-directing campaigns heading towards less-than-expected levels of success towards desirable success levels.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for incorporating contextual reinforcement to dynamically evolve an information campaign, the method comprising:
determining an evolution of an information campaign with respect to at least one end objective up to a pre-determined point of advancement in the life cycle of the information campaign;
predicting a future progression of the information campaign from the pre-determined point of advancement with respect to the at least one end objective based on said evolution and at least one learned model of progression, wherein said future progression includes a prediction of a potential outcome of the information campaign at one or more given time points in the life cycle; and
incorporating a contextual reinforcement campaign into the information campaign to dynamically evolve the information campaign toward the at least one end objective, creating an evolved information campaign, wherein the reinforcement campaign is based on said future progression;
wherein at least one of the steps is carried out by a computer device.

2. The method of claim 1, where said determining comprises determining an evolution of a class of campaigns.

3. The method of claim 2, wherein a class refers to a grouping of related campaigns.

4. The method of claim 1, where said determining comprises generating a success curve to quantify the evolution of the information campaign and to characterize a campaign class to which the information campaign belongs.

5. The method of claim 4, comprising leveraging the success curve to measure success of the information campaign with respect to the at least one end objective via comparison with success curves of other campaigns of the same campaign class.

6. The method of claim 4, comprising comparing the success curve with an expected curve of evolution of success status over time to quantify the deviation of a current status of the campaign with respect to an expected status at a given time.

7. The method of claim 1, wherein said incorporating comprises automatically incorporating a contextual reinforcement campaign into the information campaign by:
identifying existing reinforcement campaigns in an appropriate context from a repository;
scoring said identified reinforcement campaigns; and
automatically incorporating a predetermined number of the identified reinforcement campaigns.

8. The method of claim 1, wherein said incorporating comprises semi-automatically incorporating a contextual reinforcement campaign into the information campaign by:
identifying existing reinforcement campaigns in an appropriate context from a repository;
scoring said identified reinforcement campaigns; and
presenting a predetermined number of the identified reinforcement campaigns to a human reviewer for incorporation.

9. The method of claim 1, wherein said determining comprises evaluating the information campaign at one or more specified intervals of time after the information campaign is launched.

10. The method of claim 1, wherein said at least one learned model of progression includes at least one model based upon learning derived from campaigns belonging to the same class as the information campaign, and as found at similar stages from respective launches as the information campaign.

11. The method of claim 1, wherein said predicting comprises labeling the information campaign a potential failure if a number of failures greater than a pre-determined threshold of failures occur in the future progression.

12. The method of claim 1, comprising triggering composition of a contextual reinforcement campaign if the number of failures surpasses the pre-determined threshold of failures occur in the future progression.

13. The method of claim 1, wherein said determining comprises determining the evolution of the information campaign at a target level, wherein a target includes an individual or a group of individuals participating in the information campaign.

14. The method of claim 1, wherein said determining comprises determining the evolution of the information campaign across all target groups.

15. The method of claim 1, wherein said predicting comprises predicting the future progression of the information campaign at a target level, wherein a target includes an individual or a group of individuals participating in the information campaign.

16. The method of claim 1, wherein said predicting comprises predicting the future progression of the information campaign across all target groups.

17. The method of claim 1, wherein the context for a contextual reinforcement campaign is derived from the information campaign, the information campaign class, targets of the information campaign and/or prior contextual campaigns within the campaign class.

18. The method of claim 1, comprising computing a campaign-compatibility score for a target of the information campaign with respect to campaign class and the contextual reinforcement campaign.

19. An article of manufacture comprising a computer readable storage medium having computer readable instructions tangibly embodied thereon which, when implemented, cause a computer to carry out a plurality of method steps comprising:
determining an evolution of an information campaign with respect to at least one end objective up to a pre-determined point of advancement in the life cycle of the information campaign;
predicting a future progression of the information campaign from the pre-determined point of advancement with respect to the at least one end objective based on said evolution and at least one learned model of progression, wherein said future progression includes a prediction of a potential outcome of the information campaign at one or more given time points in the life cycle; and
incorporating a contextual reinforcement campaign into the information campaign to dynamically evolve the information campaign toward the at least one end objective, creating an evolved information campaign, wherein the reinforcement campaign is based on said future progression.

20. A system for incorporating contextual reinforcement to dynamically evolve an information campaign, comprising:
at least one distinct software module, each distinct software module being embodied on a tangible computer-readable medium;
a memory; and
at least one processor coupled to the memory and operative for:
determining an evolution of an information campaign with respect to at least one end objective up to a pre-determined point of advancement in the life cycle of the information campaign;
predicting a future progression of the information campaign from the pre-determined point of advancement with respect to the at least one end objective based on said evolution and at least one learned model of progression, wherein said future progression includes a prediction of a potential outcome of the information campaign at one or more given time points in the life cycle; and
incorporating a contextual reinforcement campaign into the information campaign to dynamically evolve the information campaign toward the at least one end objective, creating an evolved information campaign, wherein the reinforcement campaign is based on said future progression.
